(19) United States
(12) Patent Application Publication
(10) Pub. No.: US 2015/0083255 A1
(43) Pub. Date: Mar. 26, 2015

(54) SAFETY DESIGN FOR MEDICAL OXYGEN SUPPLY VALVEHEAD

(71) Applicant: Glenn Van Ingelgem, Londerzeel (BE)

(72) Inventor: Glenn Van Ingelgem, Londerzeel (BE)

(73) Assignee: L'Air Liquide, Societe Anonyme pour I'Etude et I'exploitation des Procedes Georges Claude, Paris (FR)

(21) Appl. No.: 14/399,798

(22) PCT Filed: May 8, 2012
(86) PCT No.: PCT/IB2012/052287

§ 371 Date: Nov. 20, 2014

(51) Int. Cl. F17C 13/04

(52) U.S. Cl. CPC F17C 13/04
USPC 137/624.27

(57) ABSTRACT

The disclosure describes a valve integrated pressure regulator in the form of a cylinder head. The device is intended for medical or emergency purposes and that is used to convert a medical or emergency gas pressure from a high, variable pressure to a lower, more constant working pressure. Two of the main features of the cylinder head design are special ignition event vent hole dimensions and configurations and a pressure regulated reversibly engaging-disengaging safety valve connected to these vent holes.

### TECHNICAL FIELD

The field of the invention is valve integrated pressure regulators intended for medical or emergency purposes and that is used to convert a medical or emergency gas pressure from a high, variable pressure to a lower, more constant working pressure.

### BACKGROUND ART

The state of the art design principles for oxygen service cylinder heads are well established. See, e.g., ASTM G88-05 Standard Guide for Designing Systems for Oxygen Service; ASTM G94-05 Standard Guide for Evaluating Metals for Oxygen Service. Great effort has gone into the design of safety features in oxygen service equipment because of the extreme material flammability that results from high concentration oxygen conditions. Despite these efforts, oxygen cylinders still suffer catastrophic failures leading to serious injuries and deaths. Even trained medical professionals are subject to this risk. For example, in 2008, two hospital staff were severely burned and a patient killed in a hospital in Creil France. While rare in hospital settings, accidents and equipment failure in home oxygen service for example are more common.

A particularly dangerous threat is fire within the cylinder head itself. Should standard valve fixtures be exposed to medical oxygen fed flames, material ignition and catastrophic failure may result. A simple countermeasure is to close off the cylinder with some form of isolation valve. This safety design is not perfect because the head or cylinder may explode due to elevated pressure.

Lives continue to be lost because the current state of technology is insufficient to counter accidental ignitions. Air Liquide has continued to invest in research and development to improve oxygen service equipment performance. The technology of course exists to make an oxygen cylinder-head system that is virtually impregnable to the consequences of an ignition event. However, the cost of such designs would make medical oxygen use cost-prohibitive. Thus the problem to be solved is to design new cylinder heads for oxygen cylinders that improve safety in a manner that makes the design feasible in view of economic realities. The obvious solutions that fit these two criteria have long been identified and implemented. The current constraints on ignition safety technology have additional consequences. Oxygen cylinders could be supplied at much higher pressures. This would be helpful for example to reduce transport and consequently greenhouse gases emission to the atmosphere. Thus a further problem to be solved is to identify oxygen cylinder head designs that improve safety verses ignition events, are economically feasible and the design is effective for significantly higher oxygen pressures than currently used.

### SUMMARY OF INVENTION

The invention may be understood in relation to the following embodiments:

A cylinder head comprising
a) an inlet (30) and an outlet (150, 160),
b) a pressure regulator (140) in fluid communication with the inlet (30) and the outlet (150, 160);
c) a safety relief valve (270) in fluid communication with the pressure regulator (140) and along a fluid release flow path (80) between the pressure regulator (140) and the outlet (150, 160);
d) an interior space (230) in fluid communication with the safety relief valve (270); and
e) three or more vent holes (210) in fluid communication with the interior space (230) and an external atmosphere (260).

In any embodiment, the safety relief valve may comprise
a) a sealing valve element (290) having a surface (295), the surface (295) in fluid communication with the pressure regulator (140); and
b) a spring (300) adapted to bias the sealing valve element (290) in a closed position,
   A) wherein the spring (300) is further adapted to yield when a pressure against the surface (295) exceeds a predetermined maximum pressure to thereby allow the sealing valve element (290) to move into an open position.

In any embodiment, there may be three to six noncontiguous vent holes (210) such as four noncontiguous vent holes (210).

In any embodiment, the spring (300) may comprise a copper beryllium alloy such as a copper alloy having 1.80-2.00% beryllium and meeting the standards of C17200 (CDA 172) as defined by ASTM B196/B196M-07.

In any embodiment, the predetermined maximum pressure to allow the sealing valve element (290) to move into an open position is from 301 to 360 bars.

In any embodiment, the outlet (160) is a connection outlet may conform to a CGA, EIGA, NF, DIN, UNI or BSI standard.

In any embodiment, the connection outlet (160) may be surrounded by a supplemental protective casing (155).

One embodiment comprises an oxygen cylinder assembly having a cylinder adapted to contain 300 bar pressure oxygen and made of seamless steel or aluminum (20) operably connected to a cylinder head (10), the cylinder head (10) comprising
a) an inlet (30) in fluid communication with a lumen (25) of the oxygen cylinder (20) and a connection outlet (160) conforming to a CGA, EIGA, NF, DIN, UNI or BSI standard;
b) a flow regulated outlet (150) in fluid communication with a flow rate regulator (170);
c) a pressure regulator (140) in fluid communication with the inlet (30) and the outlets (150, 160);
d) a safety relief valve (270) in fluid communication with the pressure regulator (140) and along the fluid release flow path (80) between the pressure regulator (140) and the outlets (150, 160);
   A) wherein the safety relief valve comprises
      a sealing valve element (290) having a surface (295), the surface (295) in fluid communication with the pressure regulator (140);
      a spring (300) adapted to bias the sealing valve element (290) in a closed position;
   B) wherein the spring (300) is further adapted to yield when a pressure against the surface (295) exceeds a predetermined maximum pressure in the range of 301 to 360 bars to thereby allow the sealing valve element (290) to move into an open position; and
   C) wherein the spring (300) comprises a copper alloy having 1.80-2.00% beryllium and meeting the standards of C17200 (CDA 172) as defined by ASTM B196/B196M-07;
e) an interior space (230) in fluid communication with the safety relief valve (270); and
f) four vent holes (210) in fluid communication with the interior space (230) and an external atmosphere (260).

One embodiment comprises an oxygen cylinder assembly having a 300 bar, seamless steel or aluminum oxygen cylinder (20) operably connected to a cylinder head (10), the cylinder head (10) comprising
a) an inlet (30) in fluid communication with a lumen (25) of the oxygen cylinder (20) and a connection outlet (160) conforming to a CGA, EIGA, NF, DIN, UNI or BSI standard;
b) a flow regulated outlet (150) in fluid communication with a flow rate regulator (170);
c) a pressure regulator (140) in fluid communication with the inlet (30) and the outlets (150, 160);
d) a safety relief valve (270) in fluid communication with the pressure regulator (140) and along the fluid release flow path (80) between the pressure regulator (140) and the outlets (150, 160);
   A) wherein the safety relief valve comprises a sealing valve element (290) having a surface (295), the surface (295) in fluid communication with the pressure regulator (140); a spring (300) adapted to bias the sealing valve element (290) in a closed position;
   B) wherein the spring (300) is further adapted to yield when a pressure against the surface (295) exceeds a predetermined maximum pressure in the range of 301 to 360 bars to thereby allow the sealing valve element (290) to move into an open position; and
   C) wherein the spring (300) comprises a copper alloy having 1.80-2.00% beryllium and meeting the standards of C17200 (CDA 172) as defined by ASTM B196/B196M-07;
e) an interior space (230) in fluid communication with the safety relief valve (270); and
f) four vent holes (210) in fluid communication with the interior space (230) and an external atmosphere (260).

A cylinder head comprising
a) A gas inletting means (30) and a gas out letting means (150, 160),
b) a pressure regulating means (140) in fluid communication with the inlet (30) and the gas out letting means (150, 160);
c) a safety relief means (270) in fluid communication with the pressure regulating means (140) and along a fluid release flow path (80) between the pressure regulating means (140) and the gas out letting means (150, 160);
d) an interior space (230) in fluid communication with the safety relief means (270); and
e) three or more venting means (210) in fluid communication with the interior space (230) and an external atmosphere (260).

### DISCLOSURE OF INVENTION

The improved design herein meets all of the above problems to be solved. Two of the main features of the cylinder head design are special ignition event vent hole dimensions and configurations and a pressure regulated reversibly engaging-disengaging safety valve connected to these vent holes.

Compared to a typical oxygen cylinder this new design has more than one or two vent holes 210 in fluid communication with a specific interior space 230 of the cylinder head. There may be for example 3-6 independent vent holes but preferably there are 4 vent holes 210.

These vent holes 210 are arranged to face different radial directions along a circumference 220 perpendicular to the main axis of the cylinder head 200. A depiction of an example of this geometry is shown in FIG. 1.

There should be significant angular space 240 between each of the vent holes 210 of at least 10 degrees along the radial arc such as 20-180 degrees. A preferred spacing is to have the vent hole 210 substantially equally spaced 240 along the radial arc. For example, if four vent holes 210 are present, each would be 90±10 degrees from the next adjacent two vent holes along the radial arc 240. The entire length of the vent holes 210 do not have to be separated by the above spacing as long as the apertures 250 communicating with the external atmosphere 260 are separated as described above. It is however highly preferred that each vent hole 210 be separate from the other vent holes 210 along the entire length of the vent holes 210 from the interior space 230 to the emission aperture 250. Further, while the spacing is described in reference to a radial arc 240 that is perpendicular to the main axis of the cylinder head, the vent holes may be, but do not have to be, in the same perpendicular plane along the main axis 200.

The vent holes 210 are also enlarged relative to standard designs. Ideally, the vent holes 210 are at least 3 mm diameter such as 3 mm-10 mm but preferably 5±0.5 mm in diameter.

The vent holes 210 will generally be in fluid communication with a single interior space 230 or chamber 230 within the cylinder head. This interior space 230 will be in fluid communication with or contain a safety relief valve 270. The safety relief valve 270 of the design is specially configured to work with the vent holes 210 and to limit the release of cylinder derived oxygen to a minimum necessary. The safety relief valve 270 is adapted to open upon pressure exceeding a safe pressure limit and to vent oxygen from the oxygen cylinder 20 through the vent holes 210. The safety relief valve 270 is further adapted to close once the pressure is sufficiently reduced to ensure the oxygen cylinder 20 does not rupture. Thus the safety release valve 270 is pressure regulated and capable of opening and closing dynamically to prevent a catastrophic pressure increase within the cylinder head 10 due to an ignition event.

The safety relief valve 270 must be constructed to withstand high oxygen burning conditions and maintain the safety valve's operational integrity. This is achieved in part by selecting materials for the valve components that will not burn in high oxygen and that will maintain their structural integrity i.e. not warp or soften when exposed to an oxygen fire. For example, one mechanism for pressure regulating the safety release valve 270 is by a specifically tensioned spring element biasing the safety release valve 270 in the closed position unless the counter pressure from the cylinder oxygen 20 exceeds an upper pressure limit (e.g. 360 bar). If the spring is to be exposed to the oxygen fire during an emergency venting by the safety release valve 270, the spring must not burn and must continue to operate within the intended parameters after such exposure.

The new vent hole design (FIG. 1) works with the safety release valve 270 to improve ventilation and reduce the time during which the cylinder head safety release valve 270 will be open. This is especially important for oxygen cylinders 20 at >200 bar pressure such as 230-360 bar pressure.

### BRIEF DESCRIPTION OF DRAWINGS

FIG. 1 shows a geometric representation of an example of the new vent hole design.

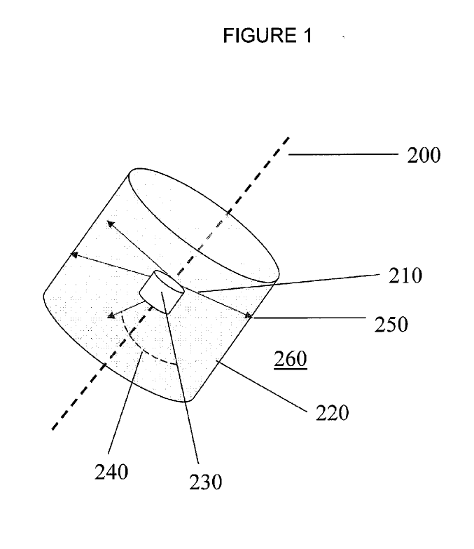

FIG. 2 shows a generalized schematic of an oxygen cylinder with a cylinder head embodiment of the invention.

FIG. 3 shows an embodiment of a pressure regulated safety valve designed to work with the new vent hole design of FIG. 1.

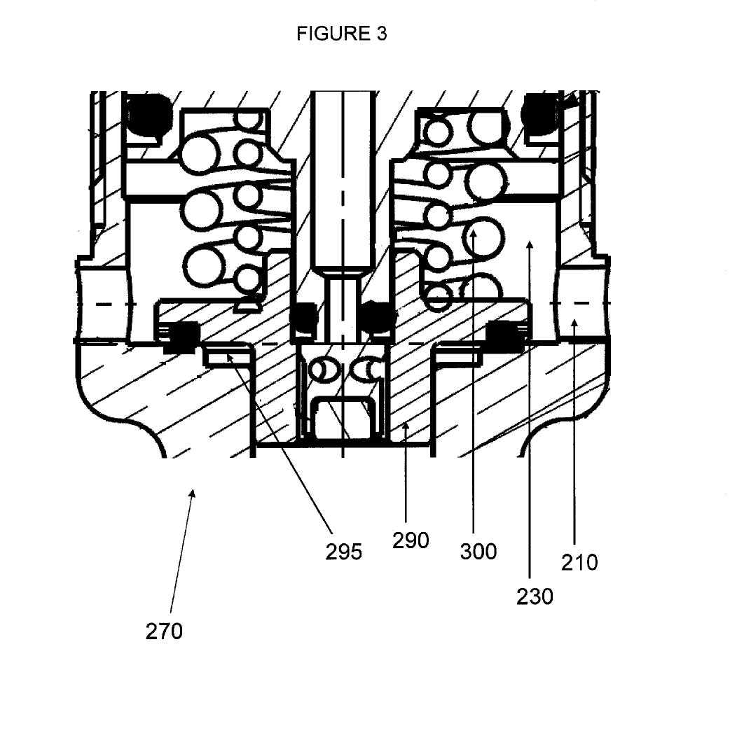

### MODE(S) FOR CARRYING OUT THE INVENTION

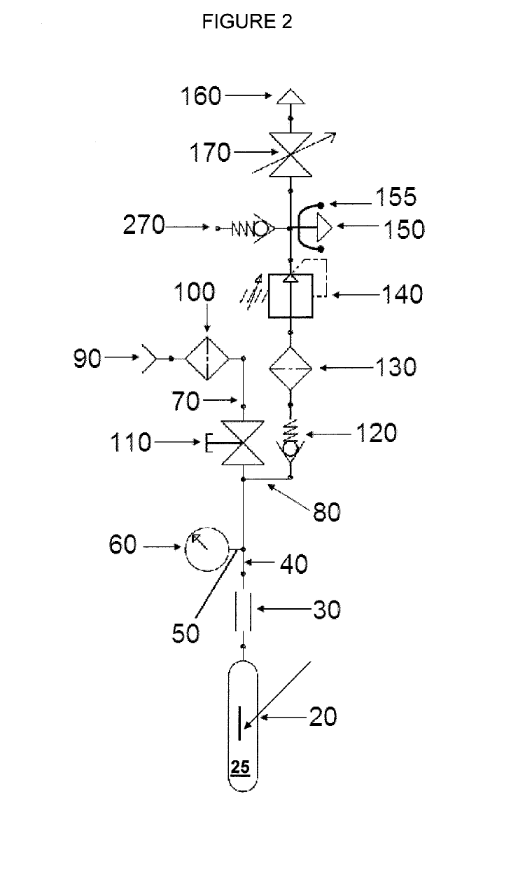

An embodiment of the invention is now described. The general schematic of an oxygen delivery apparatus is shown in FIG. 2. Oxygen cylinder 20 is a 300 bar rated seamless steel or aluminum cylinder conforming to ISO 9809-2. The Oxygen is medical grade and the cylinder head 10 is adapted to deliver oxygen suitable for human inhalation. A dip tube 30 is inserted into the lumen 25 of the cylinder 20 and in fluid communication with the oxygen therein. The dip tube 30 is further in fluid communication with a cylinder head flow path 40. Dip tube 30 functions to reduce particulates from entering the cylinder head 10 from the lumen 25 of the cylinder. The flow path for oxygen in the cylinder head optionally contains fluid connections 50 to one or more pressure gauges 60. The pressure gauge may for example sense the pressure corresponding to the lumen 25 of the oxygen cylinder 20.

The cylinder head flow path 40 preferably bifurcates into a fluid fill flow path 70 and a fluid release flow path 80. Flow paths 70 and 80 may be independent flow paths in other embodiments.

The fluid fill flow path 70 has a fluid inlet 90 adapted for connection to a source of medical oxygen. There is a particulate filter 100 in the fluid fill flow path 70 and a fluid fill valve 110. The fluid fill valve 110 may be a manual open/close valve. In an alternative embodiment, the fluid fill valve 110 prevents fluid flow from the cylinder 20 back out of the fluid inlet 90 and further operates to block fluid release flow path 80 during filling. Fluid fill valves 110 having these functional capabilities are well known in the art.

The fluid release flow path 80 diverges from the common flow path in fluid communication with the dip tube 30. The fluid release flow path 80 contains an in line residual pressure valve 120 which prevents fluid flow from the cylinder head outlet(s) back into the fluid release flow path 80 and maintains a minimum pressure in the fluid release flow path 80. Generally this residual pressure valve 120 is a check valve biased with e.g. a spring into to closed position. The residual pressure valve 120 opens when fluid pressure from within the lumen of 25 of the cylinder 20 is sufficiently high to overcome the biasing force. Residual pressure valves 120 having these functional capabilities are well known in the art. The fluid release flow path 80 may have an optional in line particulate filter 130 after the residual pressure valve 120.

Medical oxygen should be delivered at certain defined pressures that are significantly lower than the pressure in the lumen 25 of the oxygen cylinder 20. The fluid release flow path 80 therefore has an in line pressure regulator 140. The pressure regulator 140 may be fixed, pre-set or variable. The fluid release flow path 80 then continues to one or more outlets 150, 160. These outlets may be for example a CGA, EIGA, BSI, NF, DIN or UNI equipment outlet connection 150 designated for using in medical oxygen equipment. Preferably, equipment outlet connection 150 is protected by a casing 155 installed around the outlet 150 to shield the outlet 150 from damage during transport and use. As simple tube connection outlet 160 with an in line flow rate regulator 170 may present instead or in addition to equipment outlet connection 150. The in line flow rate regulator 170 preferably is configured to switch from closed to specific flow rates in Liters/minute such as 5 or 25 L/min.

The vent holes 210, the interior space 230 and the safety release valve 270 are in fluid communication with the pressure regulator 140 on side and outlets 150, 160 on the other side. Safety release valve 270 is configured so that during operation, safety release valve 270 has a surface 295 of a sealing valve element 290 in fluid communication with the oxygen after the oxygen has passed through the pressure regulator 140. Sealing valve element 290 is biased in the closed position by spring 300. If the pressure experienced by surface 295 exceeds a predefined maximum, e.g. 360 bars, the biasing force of spring 300 is overcome and sealing valve element 290 moves to open a temporary flow path into interior space 230. The overpressure gas then vents out vent holes 210. The pressure will quickly equalize with the atmosphere and spring 300 will move the sealing valve element 290 back into a closed position. The safety release valve 270 thus operates to dynamically open and close rapidly and for the minimum amount of time necessary to prevent a catastrophic over pressurization or the cylinder head 10 or oxygen cylinder 20.

Because of the safety release valve 270 is configured to dynamically and rapidly oscillate between open and closed positions, standard steel springs present a risk of sparking and creating further oxygen fire risks. To counter this, spring 300 may be constructed of Beryllium copper (BeCu) which is a copper alloy with 0.5-3% beryllium. The preferred alloy is CuBe2/C17200/CDA172 which contains approximately 2% beryllium. CuBe2 further has good resistance to stress relaxation at elevated temperatures making this alloy particularly suited for exposure to an oxygen fire in the safety release valve 270.

A 300 bar oxygen cylinder was tested with a cylinder head according to the invention and having four, independent and equally spaced vent holes. The test conformed to ASTM G175-03(2011) Standard Test Method for Evaluating the Ignition Sensitivity and Fault Tolerance of Oxygen Regulators Used for Medical and Emergency Applications, Phase 2: Regulator Inlet Promoted Ignition Test. The new safety release valve prototype conformed to the criteria required by this test.

### INDUSTRIAL APPLICABILITY

The present invention is at least industrially applicable as a cylinder head for pressure regulated oxygen from oxygen cylinders.

1. A cylinder head comprising
a) An inlet (30) and an outlet (150, 160),
b) a pressure regulator (140) in fluid communication with the inlet (30) and the outlet (150, 160);
c) a safety relief valve (270) in fluid communication with the pressure regulator (140) and along a fluid release flow path (80) between the pressure regulator (140) and the outlet (150, 160);
d) an interior space (230) in fluid communication with the safety relief valve (270); and
e) three or more vent holes (210) in fluid communication with the interior space (230) and an external atmosphere (260).

2. The cylinder head of claim 1, wherein the safety relief valve comprises
a) a sealing valve element (290) having a surface (295), the surface (295) in fluid communication with the pressure regulator (140); and
b) a spring (300) adapted to bias the sealing valve element (290) in a closed position,
A) wherein the spring (300) is further adapted to yield when a pressure against the surface (295) exceeds a predetermined maximum pressure to thereby allow the sealing valve element (290) to move into an open position.

3. The cylinder head of claim 1 having three to six noncontiguous vent holes (210).

4. The cylinder head of claim 3 having four noncontiguous vent holes (210).

5. The cylinder head of claim 2 wherein the spring (300) comprises a copper beryllium alloy.

6. The cylinder head of claim 5 wherein the spring (300) comprises a copper alloy having 1.80-2.00% beryllium and meeting the standards of C17200 (CDA 172) as defined by ASTM B196/B196M-07.

7. The cylinder head of claim 2 wherein the predetermined maximum pressure is from 301 to 360 bars.

8. The cylinder head of claim 1 wherein the outlet (160) is a connection outlet conforming to a CGA, EIGA, NF, DIN, UNI or BSI standard.

9. The cylinder head of claim 8 wherein the connection outlet (160) is surrounded by a supplemental protective casing (155).

10. An oxygen cylinder assembly comprising a 300 bar, seamless steel or aluminum oxygen cylinder (20) operably connected to a cylinder head (10), the cylinder head (10) comprising
a) an inlet (30) in fluid communication with a lumen (25) of the oxygen cylinder (20) and a connection outlet (160) conforming to a CGA, EIGA, NF, DIN, UNI or BSI standard;
b) a flow regulated outlet (150) in fluid communication with a flow rate regulator (170);
c) a pressure regulator (140) in fluid communication with the inlet (30) and the outlets (150, 160);
d) a safety relief valve (270) in fluid communication with the pressure regulator (140) and along the fluid release flow path (80) between the pressure regulator (140) and the outlets (150, 160);
A) wherein the safety relief valve comprises
a sealing valve element (290) having a surface (295), the surface (295) in fluid communication with the pressure regulator (140);
a spring (300) adapted to bias the sealing valve element (290) in a closed position;
B) wherein the spring (300) is further adapted to yield when a pressure against the surface (295) exceeds a predetermined maximum pressure in the range of 301 to 360 bars to thereby allow the sealing valve element (290) to move into an open position; and
C) wherein the spring (300) comprises a copper alloy having 1.80-2.00% beryllium and meeting the standards of C17200 (CDA 172) as defined by ASTM B196/B196M-07;
e) an interior space (230) in fluid communication with the safety relief valve (270); and
f) four vent holes (210) in fluid communication with the interior space (230) and an external atmosphere (260).

11. A cylinder head comprising
a) a gas inletting means (30) and a gas out letting means (150, 160),
b) a pressure regulating means (140) in fluid communication with the gas inletting means (30) and the gas out letting means (150, 160);
c) a safety relief means (270) in fluid communication with the pressure regulating means (140) and along a fluid release flow path (80) between the pressure regulating means (140) and the gas out letting means (150, 160);
d) an interior space (230) in fluid communication with the safety relief means (270); and
e) three or more venting means (210) in fluid communication with the interior space (230) and an external atmosphere (260).
